(19) United States
(12) Patent Application Publication
(10) Pub. No.: US 2025/0103326 A1
(43) Pub. Date: Mar. 27, 2025

(54) SYSTEM AND METHOD FOR AUTOMATIC IMPLEMENTATION OF A MIGRATION AND PORTABILITY FOR LEGACY APPLICATION SOFTWARE

(71) Applicant: Siemens Healthineers AG, Forchheim (DE)

(72) Inventors: Lutz DOMINICK, Eggolsheim (DE); Chiheb CHARRAD, Neunkirchen A. Brand (DE)

(73) Assignee: Siemens Healthineers AG, Forchheim (DE)

(21) Appl. No.: 18/888,840

(22) Filed: Sep. 18, 2024

(30) Foreign Application Priority Data
Sep. 21, 2023 (DE) 10 2023 209 198.4

(51) Int. Cl. G06F 8/76

(52) U.S. Cl. CPC G06F 8/76

(57) ABSTRACT

One or more example embodiments provides a system for implementing a migration and portability for legacy application software based on a use case, in particular a medical use case, said system comprising an input unit which is configured to read in data relating to a configuration of the legacy application software and a plurality of legacy service applications; comprising a strategy determination unit which is configured to determine a runtime architecture automatically in connection with the selected use case based on the read-in data; comprising a portability unit which is configured to load portability requirements based on the determined runtime architecture, wherein the portability requirements comprise new service applications which are linked to the legacy service applications; comprising a configuration unit which is configured to provide a new configuration of the legacy application software based on the loaded portability requirements.

### CROSS-REFERENCE TO RELATED APPLICATION(S)

The present application claims priority under 35U.S.C. § 119 to German Patent Application No. 10 2023 209198.4, filed Sep. 21, 2023, the entire contents of which are incorporated herein by reference.

### FIELD

One or more example embodiments relates to a system for automatic implementation of a migration and portability for legacy application software that is tailored to a use case. One or more example embodiments further relates to a computer-implemented method for automatic implementation of a migration and portability for legacy application software that is specific to the use case, to a computer program product, and to a nonvolatile computer-readable data storage medium.

Independent of the grammatical term usage, individuals with male, female or other gender identities are included within the term. cl RELATED ART

Legacy application software, old application software or legacy software for short (also called legacy apps), refers to software products that were launched onto the market based on old specifications and conforming to an older state of the art and that are still available even when the old specifications are no longer valid.

Using this software in environments conforming to the new specifications represents challenges which are subsumed under the generic terms of migration and portability. A migration and portability solution should preferably be performed automatically. In most cases the absence of an automatic migration and portability solution leads to the need for a manual alignment, which in general could be very time-consuming.

The portability of legacy applications and their migration into secure environments is particularly complex in medical application environments, in particular because medical applications and products usually have a service life lasting several decades. This is why a compromise is often made in organizations between maintaining the installed old system on the one hand and driving forward innovations and modernizations on the other. Added to this is the experience that in the wake of their protracted development, innovations are attended by the risk that they could be outdated within a short period of time.

All layers of a piece of application software are affected in this case, from backend service applications to frontend service applications. Backend service applications are generally more stable because they reflect the business logic, which does not often change. Frontend service applications are generally a more serious issue, in particular the user interface of the applications, which is a principal motivating factor for the modernization of legacy applications. For reasons of efficiency, the frontend service applications are often developed using technical solutions that have a limited service life, which likewise makes a swift migration difficult.

Efficient portability of an application means that there is no need to reprogram the application in the new environment. However, this requires that the technical differences between old environment and new environment should be resolved. Aspects such as security standards or runtime environments are particularly challenging in this respect. Legacy applications are often based on a monolithic architecture, which means that the cited aspects cannot be solved using state-of-the-art technologies.

Whereas in the early days of legacy apps the service applications tended to be static, today's environments require the control flow to be restructured and redesigned for the same use cases, resulting in higher portability and migration costs.

One migration and portability strategy is the use of monolithic software. Flexible software architectures based on a modular architecture have recently been introduced, for example such as microservices and microfrontends.

### SUMMARY

Generally, however, these software architectures require the portability to be in place before they can be deployed. For this reason they also provide no use-case-specific migration of applications, which significantly limits their flexibility. New use cases or the complexity of an eventual software update can generally not be realized automatically and the portability must therefore be implemented manually every time.

One or more example embodiments enables a more flexible and in particular use-case-specific implementation of a migration and portability for legacy application software.

### BRIEF DESCRIPTION OF THE DRAWINGS

At least some example embodiments are described below with reference to the following drawings. They serve to further illustrate embodiment variants of concepts and to explain various principles and advantages of these embodiment variants.

In the figures:

FIG. 1 shows a system for implementing a migration and portability for legacy application software based on a use case according to an embodiment variant of the invention;

FIG. 2 shows a schematic block diagram for illustrating the workflow of a computer-implemented method for implementing a migration and portability for legacy application software based on a use case according to an embodiment variant of the invention;

FIG. 3 shows a schematic block diagram of the migration and portability for legacy application software according to an embodiment variant of the invention;

FIG. 4 shows a schematic block diagram of the migration and portability for legacy application software for a first use case according to an embodiment variant of the invention;

FIG. 5 shows a schematic block diagram of the migration and portability for legacy application software for a second use case according to an embodiment variant of the invention;

FIG. 6 shows a schematic block diagram illustrating a computer program product according to an embodiment variant of the third aspect of the present invention; and

FIG. 7 shows a schematic block diagram illustrating a nonvolatile computer-readable data storage medium according to an embodiment variant of the fourth aspect of the present invention.

### DETAILED DESCRIPTION

According to a first aspect, one or more example embodiments provides a system for implementing a migration and portability for legacy application software based on a use case, in particular a medical use case, said system comprising an input unit which is designed to read in data relating to a configuration of the legacy application software and a plurality of legacy service applications; comprising a strategy determination unit which is configured to determine a runtime architecture automatically based on the read-in data in connection with the selected use case; comprising a portability unit which is configured to load portability requirements on the basis of the determined runtime architecture, wherein the portability requirements comprise new service applications that are linked to the legacy service applications; comprising a configuration unit which is designed to provide a new configuration of the legacy application software based on the loaded portability requirements; and comprising an output unit which is designed to execute the use case with the new configuration of the legacy application software.

Legacy application software, also called old application software or legacy app, is to be understood as a piece of software which is configured to provide a plurality of applications. In general, the legacy application software comprises different legacy service applications which can be executed in a runtime environment (comprising for example at least one hardware unit and an operating system).

A use case is any application of the legacy application software that a user can execute using the legacy application software. The use case is usually executed with actuation of a user interface. Each use case utilizes a plurality of service applications.

Legacy service applications are applications that are part of the legacy application software. They comprise the applications that were programmed at the development time of the legacy application software, together with the corresponding software updates.

New or state-of-the-art service applications are applications that are executable with current operating systems and current requirements, such as security protocols for example. The new service applications are not part of the legacy application software, but part of the migration and portability solution.

A runtime architecture is an arrangement of the different components that enable a migration and portability solution for a use case. The runtime architecture comprises a plurality of portability requirements. These relate inter alia to a determination of the runtime environment, a determination of the service applications together with the requisite service infrastructures and/or a determination of the requisite functions of the user interface. The runtime architecture also determines the link between legacy service applications and new service applications which are necessary for the portability and migration of a use case.

A new configuration of the legacy application software comprises all the information necessary to run the migration and portability solution as software. The configuration reformulates this information, which includes the runtime architecture, so that it can be executable as software.

The different facilities (units, modules and

interfaces) generally comprise devices and computer programs that are capable of receiving, processing and evaluating data. The facilities are interconnected in a wired and/or wireless manner in order to be able to exchange signals. The facilities therefore comprise at least one central processing unit (CPU) and/or at least one graphics processing unit (GPU) and/or at least one field-programmable gate array (FPGA) and/or at least one application-specific integrated circuit (ASIC) and/or an arbitrary combination of the aforementioned facilities. Each facility can further comprise a random access memory which is operatively connected to the at least one CPU, and/or a nonvolatile memory which is operatively connected to the at least one CPU and/or the random access memory. Each facility can be implemented in part and/or completely in a local device and/or in part and/or completely in a remote system, such as a cloud computing platform for example.

The different facilities can be implemented in hardware and/or software and/or partly in hardware and partly in software, wired and/or wirelessly and in any beneficial combination thereof. They can further comprise an interface to an intranet, to the internet, to a local network, to a cloud computing service, to a remote server and/or the like.

In cloud-computing-based systems, a large number of devices are connected to the cloud computing system via the internet. The devices can be located in a remote facility that is connected to the cloud computing system. The devices can comprise or consist for example of electrical or electronic devices, sensors, actuators, robots and/or machines in one or more industrial plants. The devices can be household appliances, office equipment in a residential or commercial facility, production machines, medical equipment, measuring instruments or the like.

The cloud computing system can support the remote configuration, monitoring, control and maintenance of the connected devices (also referred to generally as “assets”). The cloud computing system can also facilitate the storage of large volumes of data acquired at regular intervals by the devices, the analysis of the large volumes of data and the provision of findings (for example performance indicators, outliers, etc.) and warnings for operators, field service technicians or owners of the devices via a graphical user interface (for example of web applications). The findings and warnings can facilitate the control and maintenance of the devices, which leads to efficient and failsafe operation of the devices. The cloud computing system can also enable parameters linked to the devices to be changed. Finally, the cloud computing system can also output control commands obtained for example on the basis of the findings and warnings via the graphical user interface.

The cloud computing system can comprise a plurality of servers or processors (also referred to as a “cloud infrastructure”), which are geographically distributed and connected to one another via a network. A special platform (referred to hereinbelow as a “cloud computing platform”) is installed on the servers/processors in order to provide the above-cited functions as a service (referred to hereinbelow as a “cloud service”). The cloud computing platform can comprise a plurality of software programs which are executed on one or more servers or processors of the cloud computing system in order to enable the requested service or services to be provided for the devices and their users.

One or more application programming interfaces (APIs) are deployed in the cloud computing system in order to provide the users with different cloud services.

The strategy determination unit, the portability unit and the configuration unit can in particular execute a piece of software, a program routine or an algorithm having different data processing capabilities.

The input unit and the output interface can in particular comprise an interface, for example an application programming interface (API) so that the input unit can read in the text data and imaging data in particular and the output interface can output the processed imaging data with the segmentation.

The strategy determination unit and/or the portability unit can include an artificial intelligence module.

Artificial intelligence is to be understood as a computer-aided unit or facility which is embodied to implement different data analysis methods, which are generally referred to also as artificial intelligence, machine learning, deep learning, computer learning or the like. At the core of the majority of facilities having artificial intelligence is a trained or trainable artificial neural network (ANN).

Herein and in the following, an artificial neural network (often also referred to as an encoder) is to be understood as a computing system which is based on a collection of connected units or nodes which are organized into one or more tiers or layers that are able to transmit signals to one another, and which preferably at least partly comprises a transformer network architecture.

According to some examples, the portability facility is embodied to identify legacy service applications (necessary for the use case) based on the runtime architecture and to link the identified legacy service applications to new service applications in order to provide the portability requirements.

According to some examples, the portability unit is embodied to link new service applications and the legacy service applications to one another based on a semantic relationship.

A semantic relationship enables applications to be linked situatively based on (abstract) properties of the applications. The link is therefore not realized based on predefined link tables. A link between legacy service applications and new service applications can accordingly be created also for unknown runtime architectures/use cases and an executable configuration can be provided.

According to some examples, the portability unit for establishing the semantic relationship is embodied to categorize the legacy service applications based on semantics in order to provide a legacy categorization, to categorize new service applications based on the semantics in order to provide a new categorization, and to link the legacy service applications and new service applications to one another based on the legacy categorization and the new categorization.

In other words, the legacy service applications and the new service applications can be classified according to the semantics. The semantics can comprise for example a function, a meaning, a behavior, input/output variables and/or further properties and/or an arbitrary combination of the aforementioned properties. In addition, the semantics can also comprise less tangible properties. In particular, the semantics can be semantics learned via machine learning.

Providing a categorization (legacy or new) may in particular comprise generating a feature vector for the respective service application based on the semantics. A link between legacy service application and new service application may be based in particular on a comparison of the respective feature vectors. In particular, legacy service applications and new service applications with similar or the same feature vectors can be linked to one another. A similarity between feature vectors can be determined for example by forming the cosine. A feature vector can in particular comprise one or more properties of the service application.

As a result of such a semantic analysis, it is possible also in such use cases to generate links in which no 1-to-1 correspondence is present between the legacy service applications and the new service applications.

According to some examples, the portability facility is embodied to determine the semantics based on the runtime architecture.

For example, depending on the runtime architecture, certain features/properties of the semantics can be defined (activated or deactivated) which are relevant to the underlying use case. Thus, depending on the hardware or operating system or the searched-for functionality, different properties are important in the linking of service applications. This enables the semantic relationship to be fitted dynamically to the respective use case.

According to a second aspect, one or more example embodiments further provides a computer-implemented method for implementing a migration and portability for legacy application software, comprising the steps: selecting a use case; reading in data relating to a configuration of the legacy application software and a plurality of legacy service applications; automatically determining, on the basis of the read-in data, a runtime architecture in connection with the selected use case; loading portability requirements on the basis of the determined runtime architecture, wherein the portability requirements comprise new service applications that are linked to the legacy service applications; providing a new configuration of the legacy application software based on the loaded portability requirements; and executing the selected use case with the new configuration of the legacy application software.

The computer-implemented method according to the second aspect of one or more example embodiments can advantageously be performed for example with the system according to the first aspect of one or more example embodiments. The features and advantages described herein in connection with the system and its mode of operation therefore apply in the same way also to the method, and vice versa.

According to a third aspect, one or more example embodiments further provides a computer program product comprising an executable program code which is configured, when executed, to perform the method according to the second aspect of the present invention.

According to a fourth aspect, one or more example embodiments provides a nonvolatile computer-readable data storage medium comprising an executable program code which is embodied, when executed, to perform the method according to the second aspect of the present invention.

The nonvolatile computer-readable data storage medium can comprise or consist of any type of hardware memory, in particular a semiconductor memory, for example such as a solid-state memory. The data storage medium can also comprise or consist of a CD, a DVD, a Blu-ray disc, a USB memory stick, a hard disk drive or the like.

An idea underlying one or more example embodiments consists in providing a system for implementing a portability and migration strategy for legacy application software which determines a separate migration and portability solution on the basis of a given use case. The solution is based on linking state-of-the-art software applications to the legacy applications. Each use case has a different, automatically determined link strategy. Two use cases can be executed in succession by replacing the link strategy of the first use case by the link strategy of the second use case. By implementing and de-implementing link strategies, the legacy application software can be applied to different use cases.

The system described above advantageously enables an implementation of a computer-implemented method for performing a use-case-based migration and porting of legacy application software. This firstly entails selecting a use case. Data relating to the configuration of the legacy application software and the available legacy service applications is read in. A suitable runtime architecture is thereupon determined automatically for the selected use case. On the basis thereof, the associated portability requirements, for example such as state-of-the-art service applications, are loaded and linked to the legacy service applications. This link strategy provides a new configuration of the legacy application software which is tailored to the selected use case. The use case selected at a given time or pending for selection can be executed using the new configuration.

An advantage of the present invention resides in the fact that the portability and migration of legacy application software can be tailored separately to different use cases by the linking of different state-of-the-art software applications to legacy applications. This linking should be determined according to the particular use case and runs automatically. The portability and migration are therefore realized by linking state-of-the-art software applications, said linking being dependent on the use case. The legacy application software consequently remains unchanged. This ensures a flexible and self-adaptive migration.

A further advantage of one or more example embodiments resides in the fact that the new software components and the legacy software components are linked in such a way that the legacy application software is able to invoke and run the different legacy service applications in the usual way.

A further advantage of one or more example embodiments resides in the fact that the legacy applications and the state-of-the-art applications can be updated separately without adversely affecting the portability and migration.

Advantageous embodiments and developments will become apparent from the further dependent claims, as well as from the description with reference to the figures of the drawing.

According to further embodiment variants of the invention, it is provided that the legacy application software is medical legacy application software. Portability and migration solutions are particularly relevant in the medical sector since the service life or update frequency of many medical software applications can vary considerably. For example, the service applications of a medical app must be adapted to frequently changing security measures. As a consequence, it is important to resolve legacy problems that occur in connection with medical legacy application software as swiftly as possible.

According to further embodiment variants of the invention, it is provided that the new configuration of the legacy application software comprises a change to subsections of the legacy application software in which only some of the legacy service applications are used and/or parts of a user interface are replaced. Subsections of the legacy application software comprise for example a runtime environment, the legacy service applications and the service infrastructures (for example licenses, data accesses, data transfers, security requirements and other statutory requirements), a user interface, as well as other functional and non-functional requirements. According to one or more example embodiments, the number of active legacy service applications and the respective links to new service applications are organized very flexibly and are dependent on the use case. For a given use case, the appropriate determined runtime architecture may require certain legacy service applications to be dispensed with. For another use case, it may be necessary to replace parts of the user interface.

According to further embodiment variants of the invention, it is provided that the portability requirements further include a runtime environment and/or security properties and/or a configuration of a user interface. The link strategies according to one or more example embodiments enable the different subsections of the legacy application software to be replaced or added to. The ability to change and adapt all the subsections of the legacy application software accordingly allows the portability requirements also to be designed for flexibility.

According to further embodiment variants of the invention, it is provided that the portability unit is additionally designed to adapt the configuration of the user interface in order to provide access to new service applications which are not linked to the legacy service applications. According to one or more example embodiments, the legacy service applications should be executed by way of the legacy user interface, even if they are linked to new service applications. New service applications that are not linked to any legacy applications, on the other hand, can be executed by making changes to the user interface. Expanding the service applications of the legacy application software in order to make new service applications available is also to be understood as migration and portability. A use case may require a current security login, for example. This new service application cannot be invoked via the legacy user interface. However, a new configuration of the user interface (by replacing or supplementing some parts of the user interface) can provide the security login as a new service application.

According to further embodiment variants of the invention, it is provided that the system additionally includes a database unit which is configured to provide at least one list of use cases, a list of new service applications and a list of runtime architectures. Use cases can therefore be chosen by a user. The determined runtime architectures can likewise be selected from a list. A runtime architecture can be implemented with a list of portability requirements. The system of one or more example embodiments can call up the portability requirements from a list of new service applications. The database unit is therefore to be understood to some extent as a software library. The runtime architectures and portability requirements determined by the system could be stored as retrievable in the database unit. The stored runtime architectures comprise metadata which relates the runtime architectures to the new service applications and the portability requirements (for example the different links required).

According to further embodiment variants of the invention, it is provided that the portability requirements comprise changes to a frontend of the legacy application software as well as changes to a backend of the legacy application software, which changes are mutually independent of one another. It is often the case that the frontend of a piece of application software needs to be updated more frequently than its backend. The user interface of an app and the security measures usually change more quickly than the use cases. With legacy application software, there are therefore different needs which require separate solutions. According to one or more example embodiments, the new applications and the legacy applications are decoupled from one another. They can be connected in accordance with the different link strategies. The links can be canceled independently of one another. Accordingly, it is possible to change a link, for example because an update that relates only to said link is required. This flexibility of the system according to one or more example embodiments enables the requirements of the frontend and the backend to be handled independently of one another.

According to further embodiment variants of the invention, it is provided that the portability unit is further configured to cooperatively interact with a traditional runtime architecture, in particular a runtime architecture including microservices or microfrontends. A consequence of this flexibility and adaptability of one or more example embodiments is that it can work in combination with conventional modular and flexible software architectures.

According to further embodiment variants of the invention, it is provided that the system also includes a validation unit which is configured to validate the implemented migration and portability, in particular in order to initiate repairs or a refilling of the database unit. In some circumstances for example it might not be possible to implement the migration and portability solution provided by the determined runtime architecture because no suitable new service applications were found in the database unit or because a compatibility problem has occurred. The validation unit ensures that these problems are detected and identified.

According to further embodiment variants of the invention, it is provided that the portability unit is further configured to perform an orchestration of the loaded portability requirements and to redirect execution calls from the legacy application software to the portability requirements. The legacy application software is ported without changing the existing execution calls. The redirection of the execution calls can be part of the link strategy. The link strategy can also comprise an orchestration of the new service applications and the legacy service applications.

According to further embodiment variants of the invention, it is provided that the runtime architecture is implemented in a desktop or in a container, in particular in an edge or cloud environment. The migration solution of one or more example embodiments ensures that the use cases of the legacy application software can be executed in different runtime environments.

According to further embodiment variants of the invention, it is provided that the system also includes a memory unit which is configured to store the new configuration of the legacy application software. Accordingly, all the information for reuse is available and can be changed and retrieved under version control.

Although some functions here and also in the following are described as executed by units or facilities, this does not necessarily mean that said units or facilities are provided as units or facilities that are self-contained, related to or separate from one another. In cases in which one or more units or facilities or also a part thereof are provided as software, the units or facilities can be implemented via program code sections or program code segments that may be separate from one another but may also be interwoven or integrated with one another. Program codes comprising program code sections or program code segments that are distributed over multiple units or facilities, as is possible for example in the case of cloud computing, are also conceivable.

Similarly, in cases in which one or more units and/or facilities are provided as hardware, the functions of one or more units or facilities can be provided by one and the same hardware component or the functions of one or more units or facilities can be distributed over multiple hardware components which do not necessarily have to correspond to the units or facilities. Each application, each system, each method etc. can therefore possess all of the features and functions attributed to a particular unit or particular facilities and comprise or implement said unit or facilities. In particular it is possible that all of the units are implemented via program code that is executed for example by a server or a cloud computing platform.

Where beneficial, the above embodiments and developments can be combined with one another in any desired fashion. Further possible embodiments, developments and implementations of the invention also comprise not explicitly cited combinations of features of the invention described hereintofore or hereinbelow in respect of the exemplary embodiments. In particular, the person skilled in the art will in this regard also add individual aspects as improvements or supplements to the respective basic form of the present invention.

The further scope of the applicability of the present method and the device will become apparent from the following figures, the detailed description and the claims. It should be understood, however, that the detailed description and the specific examples, while disclosing preferred embodiment variants of the invention, serve primarily for illustration purposes and that different variations and modifications within the underlying idea and scope of the invention are discernible by persons skilled in the art.

Unless stated otherwise, like, identical or functionally similar elements are in each case labeled with the same reference signs in the figures of the drawing.

Elements depicted in the figures of the drawing are not necessarily represented true to scale. The drawings serve primarily to illustrate and clarify the basis and principles of the present invention. In similar fashion, known structures and devices are represented in some cases in the form of block diagrams in order to illustrate possible concepts of the present invention.

The numbering of the steps in the methods is intended to simplify their description. They do not necessarily imply a specific order of the steps, unless explicitly stated otherwise. In particular, several steps may also be carried out concurrently and/or multiple times and/or intermediate steps that are not shown may be present.

The detailed description of the attached figures of the drawing contains specific details in order to allow a comprehensive understanding of the present invention. It will however be clear to the person skilled in the art that the present invention can, where appropriate, also be implemented without these specific details.

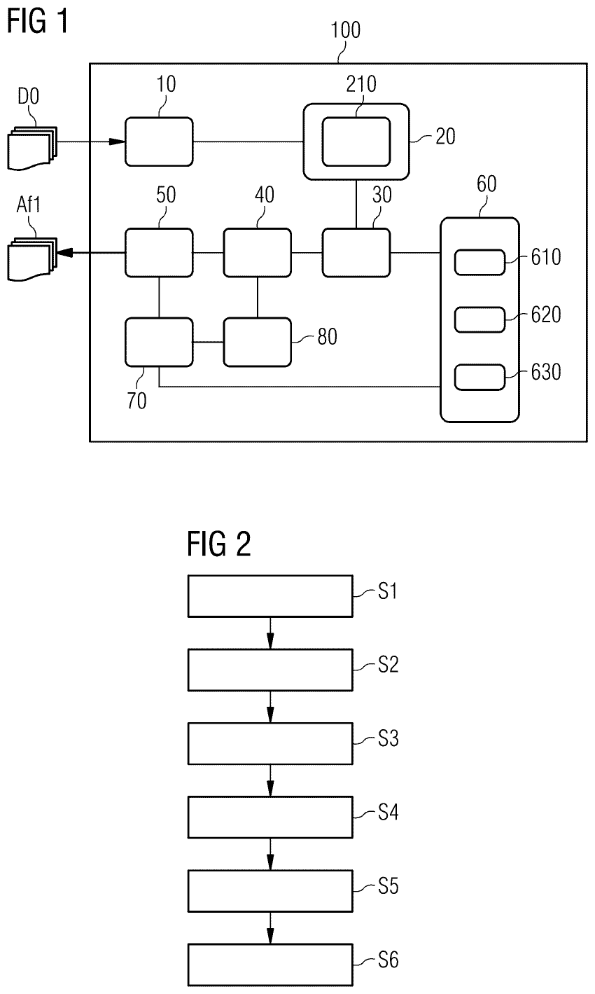

FIG. 1 shows a system 100 for implementing a migration and portability for legacy application software based on a use case according to an embodiment variant of the invention. The legacy application software can be medical legacy application software, for example in order to read or report information concerning patients, for example such as the treatment, the planned and proposed interventions, the result of a test, etc.

The system 100 comprises an input unit 10, a strategy determination unit 20, a portability unit 30, a configuration unit 40, an output unit 50, a database unit 60, a validation unit 70 and a memory unit 80.

The input unit 10 is designed to read in data DO relating to the present configuration of the legacy application software. This data DO comprises inter alia the available legacy service applications, the runtime environment of the legacy application software and information relating to the service infrastructures.

The strategy determination unit 20 is configured to determine a runtime architecture in connection with the selected use case. The determination takes the read-in data DO and a new runtime architecture is provided on the basis thereof. The runtime architecture can be implemented in a desktop or in a container, in particular in an edge or cloud environment. In some embodiment variants of the invention, the runtime architecture is determined using an algorithm. In other embodiment variants, the strategy determination unit 20 can comprise an artificial intelligence module 210 which implements an artificial intelligence model. The artificial intelligence module 210 can be part of the algorithm and/or can be used to optimize the algorithm.

The portability unit 30 is configured to load portability requirements corresponding to the determined runtime architecture. Portability requirements relate to all the software components of an application software package and its requisite links. Portability requirements comprise changes to a frontend of the legacy application software and/or changes to a backend of the legacy application software, which could preferably be implemented independently of one another. Portability requirements are use-case-dependent and may therefore comprise the runtime environment, the user interface and the service applications in connection with a use case. It is therefore possible for portability requirements to comprise new service applications and legacy service applications, preferably together with information relating to how they must be connected. The portability unit 30 can additionally be configured to cooperatively interact with a traditional runtime architecture, in particular one that includes microservices or microfrontends. The portability unit 30 may also be configured to perform an orchestration of the loaded portability requirements and to redirect execution calls from the legacy application software to the portability requirements.

The configuration unit 40 is designed to provide a new configuration of the legacy application software based on the loaded portability requirements. In some embodiment variants of the invention, the configuration can be compiled as executable code.

The output unit 50 serves to execute the use case with the new configuration of the legacy application software. The output unit 50 may comprise at least one CPU, a data memory and an interface, for example an application programming interface (API). The API can be coupled to the legacy application software wirelessly and/or via a wired cable connection.

In some embodiment variants, such as illustrated in FIG. 1, the system 100 further comprises a database unit 60. The database unit 60 is designed to provide at least one list of use cases, a list of new service applications and/or a list of runtime architectures. In some embodiment variants, the database unit 60 comprises a use case module 610 which is configured to maintain or archive a list of use cases. In further embodiment variants, the database unit 60 comprises a runtime architecture module 620 which is configured to maintain or archive a list of new runtime architectures. In other embodiment variants, the database unit 60 comprises a service application module 630 which is configured to maintain or archive a list of new service applications. In the embodiment variant shown in FIG. 1, the database unit 60 comprises a use case module 610, a runtime architecture module 620 and a service application module 630.

The use case module 610 can be connected to a user interface. The available use cases can therefore be chosen by a user from a list of use cases.

The runtime architecture module 620 can maintain runtime architectures (including runtime architectures determined by the strategy determination unit 20) in a list. A runtime architecture can be stored along with information relating to the corresponding portability requirements. The stored runtime architectures comprise metadata which relates the runtime architectures to the new service applications and the portability requirements, for example the different links required.

In some embodiment variants of the invention, the portability unit 30 can select a runtime architecture suitable for a use case from the runtime architecture module 620 of the database unit 60. This is particularly advantageous when the migration and portability solution for the use case has already been determined beforehand by the strategy determination unit 20. This can be implemented in accordance with different variants. According to one variant, the determination by the strategy determination unit 20 can be initiated by the input unit 10 if a runtime architecture has so far still not been determined already for the selected use case.

At least some of the new service applications in connection with the portability requirements of a runtime architecture can be invoked by the service application module 630.

The system 100 of FIG. 1 further comprises a validation unit 70 which is configured to validate the implemented migration and portability, in particular in order to initiate repairs or a refilling of the database unit 60. In some circumstances it may not be possible to implement the migration and portability solution provided by the determined runtime architecture. In some cases it may be possible that no suitable new service applications have been found. Consequently, the portability requirements cannot be met. In other cases, a compatibility problem could occur. The validation unit 70 ensures that the different problems are detected and identified. Information concerning the problems that have occurred can be forwarded to a user by way of a user interface. The validation unit 70 can comprise a CPU, a data memory and an interface, for example an application programming interface (API). The API can be coupled to a user interface wirelessly or via a wired cable connection.

The memory unit 80 shown in FIG. 1 is configured to store the new configuration of the legacy application software. Configurations in connection with use cases can be retrieved as needed from the memory unit 80 and used. The memory unit 80 can be a data storage medium, for example such as a DVD, a hard disk drive, a USB memory or the like. Alternatively, the memory unit 80 can also be part of a computer or server and/or be located in a cloud platform. According to some embodiment variants, the memory unit 80 can be incorporated in the database unit 60.

FIG. 2 shows a schematic block diagram intended to illustrate the workflow of a computer-implemented method for implementing a migration and portability for legacy application software based on a use case according to an embodiment variant of the invention. The method can advantageously be carried out via a system 100 according to FIG. 1.

In a step S1, a use case is selected. This can be done by a user, for example using a suitable user interface. In some embodiment variants of the invention, the user interface can provide a list of use cases which could be called up from a database unit 60, for example. The user interface can be coupled to the database unit 60 wirelessly or via a wired cable connection.

In a step S2, data D0 in connection with the present configuration of the legacy application software is read in, among which data a plurality of legacy service applications are present.

In a further, following step S3, a runtime architecture tailored to the use case is determined automatically. The automatic determination can be carried out using a suitable algorithm, for example an algorithm which contains a trained or trainable artificial intelligence model.

In a step S4, portability requirements enabling an implementation of the determined runtime architecture are loaded. Portability requirements relate to all the software components of an application software package and to the necessary links with one another. Portability requirements may therefore comprise new service applications and legacy service applications, together with information relating to how they should be connected.

In the next step S5, a new configuration of the legacy application software is provided. In some embodiment variants, the configuration can be compiled as executable code and kept in a memory unit 80.

Finally, in step S6, the selected use case is executed with the new configuration of the legacy application software. The configuration can be retrieved from the memory unit 80.

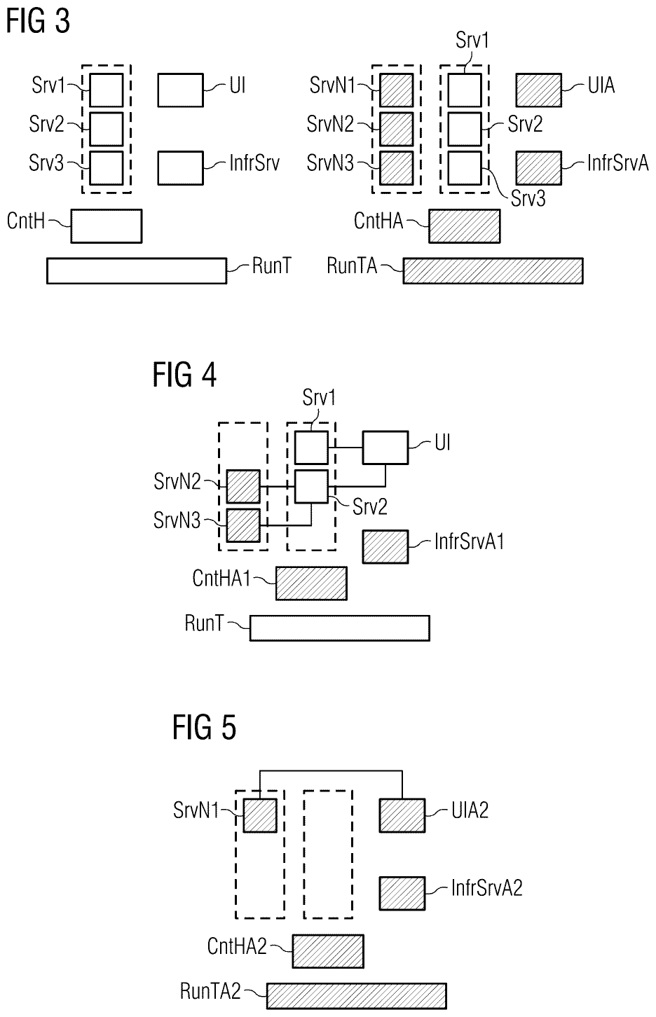

FIG. 3 shows a schematic block diagram intended to illustrate the migration and portability of a legacy application software package according to an embodiment variant of the invention. The block diagram shows a piece of legacy application software comprising legacy service applications Srv1, Srv2 and Srv3, a legacy user interface UI and a service infrastructure InfrSrv. The use case is executed via the legacy application software with the aid of a container CntH in a runtime environment RunT. The runtime environment RunT comprises an operating system and hardware. The different use cases which can be executed using the legacy application software can be called up by way of the legacy user interface UI. Each use case utilizes different combinations of the service applications Srv1, Srv2 and Srv3.

Also shown in the block diagram of FIG. 3 is the legacy application software as ported according to one or more example embodiments. FIG. 3 shows a possible runtime architecture which could be provided in connection with a use case. In addition to the legacy service applications Srv1, Srv2 and Srv3, new service applications SrvN1, SrvN2 and SrvN3 are shown in FIG. 3, together with a user interface UIA and a service infrastructure InfrSrVA. The different use cases can be executed with the ported legacy application software with the aid of a container CntHA in a runtime environment RunTA.

The runtime architecture shown on the right-hand side of FIG. 3 has been determined by the strategy determination unit 20. The portability unit 30 can retrieve the necessary new service applications SrvN1, SrvN2 and SrvN3 from the service application module 630 of the database unit 60 and link them to the legacy service applications Srv1, Srv2 and Srv3 and the user interface UIA. The link is designed in such a way that the legacy service applications of the legacy service applications Srv1, Srv2 and Srv3 which are linked to new service applications of the service applications SrvN1, SrvN2 and SrvN3 should be executed in exactly the same way as prior to the portability and migration. This is achieved in that the affected components of the user interface UIA originate from the legacy user interface UI. New service applications of the service applications SrvN1, SrvN2 and SrvN3 which are not linked to any legacy applications Srv1, Srv2 and Srv3, on the other hand, can be executed by replaced components of the user interface UIA.

The determined runtime architecture further ensures that the use case can be executed with the ported legacy application software in the new runtime environment RunTA with the aid of the container CntHA.

FIG. 4 shows a further schematic block diagram intended to illustrate the migration and portability of a legacy application software package for a first use case according to an embodiment variant of the invention. The determined runtime architecture, which provides a migration and portability solution for the use case, defines as portability requirements the legacy service applications Srv1 and Srv2, the legacy user interface UI, the new service applications SrvN2 and SrvN3, a new service infrastructure InfrSrvA1, a new container CntHAI and the legacy runtime environment RunT. The legacy service applications Srv1 and Srv2 are linked to the legacy user interface UI.

According to the example illustrated in FIG. 4, a new service infrastructure InfrSrvA1 and a new container CntHA1 are required in order to implement the new service applications SrvN2 and SrvN3. The new service infrastructure InfrSrvA1 may comprise current licenses or information about the data transfer. In medical software applications, the data transfer is regulated for example via a set of rules and specifications called Fast Healthcare Interoperability Resources (FHIR).

The new service applications SrvN2 and SrvN3 are linked to the legacy service application Srv2. The portability unit 30 ensures that this link is configured in such a way that the legacy service application Srv2 can be executed using the user interface UI in exactly the same way as prior to the portability and migration.

FIG. 5 shows a schematic block diagram of the migration and portability of a legacy application software package for a second use case according to an embodiment variant of the invention. In this example, the corresponding determined runtime architecture comprises a new service application SrvN1, no legacy service applications, a changed user interface UIA2, a new service infrastructure InfrSrvA2, a new container CntHA2 and a new runtime environment RunTA2.

The new service application SrvN1 can be executed by way of the user interface UIA. The illustrated use case may be a security login, for example. The new service application SrvN1 cannot be invoked using the legacy user interface. The configuration of the user interface UIA2, which can be accomplished for example by replacing or supplementing some parts of the user interface UI, can provide the required security login. The security login is based on current security protocols which are implemented for example in the new service infrastructure InfrSrvA2. Typically, the security login cannot be performed with Windows 8 (as an example of a legacy operating system), but instead Windows 11 (as an example of an updated operating system) is required for this. A new runtime environment RunTA2 and a new container CntHA2 are required in order to be able to perform the security login with the ported legacy application.

In FIG. 4 and FIG. 5, the determined runtime architecture could cooperatively interact with a traditional runtime architecture, in particular a runtime architecture that includes microservices or microfrontends. The user interface UIA2 shown in FIG. 5 could be configured with microservices, for example.

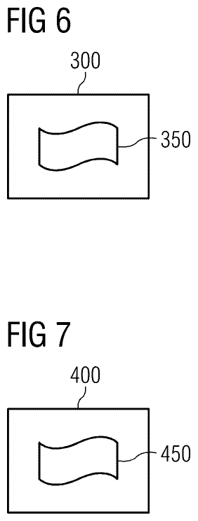

FIG. 6 shows a schematic block diagram that illustrates a computer program product 300 according to an embodiment variant of the third aspect of the present invention. The computer program product 300 comprises an executable program code 350 which is configured in such a way that, when executed, it performs the method according to any desired embodiment variant of the second aspect of the present invention, in particular as has been described in the preceding FIGS. 1-5.

FIG. 7 shows a schematic block diagram that

illustrates a nonvolatile computer-readable data storage medium 400 according to an embodiment variant of the fourth aspect of the present invention. The data storage medium 400 comprises an executable program code 450 which is configured in such a way that, when executed, it performs the method according to any desired embodiment variant of the second aspect of the present invention, in particular as has been described in the preceding FIGS. 1-5. The nonvolatile computer-readable data storage medium may comprise any type of computer storage, in particular it may be embodied as semiconductor memory or solid-state memory or consist thereof. The data storage medium may also comprise a CD, a DVD, a Blu-ray disc, a hard disk drive, a USB memory stick or similar, consist of such and/or as described below. Cloud-based storage services would also be conceivable.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative used descriptors herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be using hardware, implemented software, and/or a combination thereof. For example, hardware devices may be implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more and/or the one or more computer processing storage devices devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java@, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

1. A system for implementing a migration and portability for legacy application software based on a use case, the system comprising:
an input unit configured to read in data relating to a configuration of the legacy application software and a plurality of legacy service applications;
a strategy determination unit configured to automatically determine, based on the read-in data, a runtime architecture in connection with the selected use case;
a portability unit configured to load portability requirements based on the determined runtime architecture, wherein the portability requirements comprise new service applications linked to the legacy service applications;
a configuration unit configured to provide a new configuration of the legacy application software based on the loaded portability requirements; and
an output unit configured to execute the use case with the new configuration of the legacy application software.

2. The system of claim 1, wherein the legacy application software is medical legacy application software.

3. The system of claim 1, in which the portability unit is configured to link new service applications to the legacy service applications based on a semantic relationship with one another.

4. The system of claim 3, wherein the portability unit is configured to:
categorize the legacy service applications based on semantics to provide a legacy categorization,
categorize new service applications based on the semantics to provide a new categorization, and
link the legacy service applications and new service applications to one another based on the legacy categorization and the new categorization.

5. The system of claim 4, wherein the portability unit is configured to determine the semantics based on the runtime architecture.

6. The system of claim 1, wherein the new configuration of the legacy application software comprises a change to subsections of the legacy application software.

7. The system of claim 1, wherein the portability requirements further include at least one of a runtime environment, security properties or a configuration of a user interface.

8. The system of claim 7, wherein the portability unit is configured to adapt the configuration of the user interface to provide access to new service applications which are not linked to the legacy service applications.

9. The system of claim 1, further comprising:
a database unit configured to provide at least one list of use cases, a list of new service applications and a list of runtime architectures.

10. The system of claim 1, wherein the portability requirements comprise changes to a frontend of the legacy application software and changes to a backend of the legacy application software, the changes to the frontend of the legacy application software and the changes to the backend of the legacy application software are mutually independent of one another.

11. The system of claim 1, wherein the portability unit is configured to cooperatively interact with a traditional runtime architecture.

12. The system of claim 1, further comprising:
a validation unit configured to validate the implemented migration and portability.

13. The system of claim 1, wherein the portability unit is configured to perform an orchestration of the loaded portability requirements and to redirect execution calls from the legacy application software to the portability requirements.

14. The system of claim 1, wherein the runtime architecture is implemented in a desktop or in a container.

15. The system of claim 1, further comprising:
a memory unit configured to store the new configuration of the legacy application software.

16. A computer-implemented method for implementing a migration and portability for legacy application software, the method comprising:
selecting a use case;
reading in data relating to a configuration of the legacy application software and a plurality of legacy service applications;
automatically determining a runtime architecture in connection with the selected use case, based on the read-in data;
loading portability requirements based on the determined runtime architecture, wherein the portability requirements comprise new service applications which are linked to the legacy service applications;
providing a new configuration of the legacy application software based on the loaded portability requirements; and
executing the selected use case with the new configuration of the legacy application software.

17. A non-transitory computer program product comprising an executable program code, when executed by a system, cause the system to perform the computer-implemented method of claim 16.

18. A non-transitory, nonvolatile computer-readable data storage medium comprising an executable program code, when executed by a system, cause the system to perform the computer-implemented method of claim 16.

19. The system of claim 11, wherein the portability unit is configured to cooperatively interact with a runtime architecture including microservices or microfrontends.

20. The system of claim 12, wherein the validation unit is configured to validate the implemented migration and portability to initiate repairs or a refilling of the database unit.
